(19) United States
(12) Patent Application Publication
(10) Pub. No.: US 2007/0128395 A1
(43) Pub. Date: Jun. 7, 2007

(54) PEEL-AWAY TECHNICAL INFORMATION LABEL

(75) Inventor: Matthew Gonzales, Madison, WI (US)

Correspondence Address: FOLEY & LARDNER LLP, 150 EAST GILMAN STREET, P.O. BOX 1497, MADISON, WI, 53701-1497, US

(73) Assignee: EMD Biosciences, Inc.

(21) Appl. No.: 11/566,520

(22) Filed: Dec. 4, 2006

Related U.S. Application Data
(60) Provisional application No. 60/742,467, filed on Dec. 5, 2005.

(51) Int. Cl. B32B 33/00

(52) U.S. Cl. 428/40.1; 428/43

(57) ABSTRACT

This invention relates to labeling systems. More specifically, the invention relates to multi-part labeling systems for use on reagent or specimen bottles for labeling the bottle and providing information on a removable portion. Thus the invention provides a label with a peel-away portion containing important information that may be reapplied to another surface, while a portion of the label remains attached to a container holding or intended to hold contents. The label, the container with the label, and methods of using the label are provided.

### CROSS-REFERENCES TO RELATED APPLICATIONS

This application is based upon and claims the benefit of U.S. Provisional Application No. 60/742,467, filed on Dec. 5, 2005, the entire disclosure of which is incorporated herein by reference.

### FIELD OF THE INVENTION

This invention relates to labeling systems. More specifically, the invention relates to multi-part labeling systems for use on reagent or specimen bottles.

### BACKGROUND

Labeling systems are ubiquitous throughout industrial, research, retail, and home settings. In the area of research-related products, there are a number of ways for vendors to supply materials to researchers. When an individual in an industrial or research setting receives a sample for testing or for use in other applications, they typically receive the container with the desired materials contained therein. Accompanying the container and contents may be a certificate of analysis, material safety data sheet (MSDS), warranty of material, or other identifying or safety information that the individual may require. The individual can then staple, tape, paperclip, or copy that analysis or safety information into a notebook, receipt, ledger, log book, or other recordation device. Such a manner of transferring important information to a researcher or other individual in need of such information is bulky and runs the risk of losing the information before it can be recorded. There exists a need to provide this information in a manner that is reliable, easily accompanies the container and contents, and is not bulky or obtrusive to the user. To address those needs, the present invention provides a label and methods for using the label.

### SUMMARY

In one aspect, a label is provided comprising: a release liner comprising a release surface and a release liner adhesive layer; a first indicia-containing film comprising a first indicia-containing surface and a first adhesive layer in contact with the release surface of the release liner; and a second indicia-containing film comprising a second indicia-containing surface, and a second adhesive layer in contact with the release surface of the release liner.

In some embodiments, the label further comprises a backing strip in contact with and releasably attached to the release liner adhesive layer. In other embodiments, the first adhesive layer adheres more strongly to the release surface than does the second adhesive layer.

In another aspect, a labeled container is provided comprising: a container having an outer surface; and a label as embodied herein, wherein the release liner adhesive layer is in contact with the outer surface of the container. In some embodiments, the first and second indicia-containing surfaces comprise information regarding actual or intended contents of the container.

In yet another aspect, methods for applying a label to a container are provided comprising, contacting the release liner adhesive layer to an outer surface of the container. The embodied methods may further comprise removing or peeling the second indicia-containing film from the release surface of the release liner.

In other aspects, labels are provided comprising: a first release liner comprising a first release surface; a first indicia-containing film comprising a first indicia-containing surface and a first adhesive layer in contact with the first release surface; a second indicia-containing film comprising a second indicia-containing surface and a second adhesive layer; and a second release liner comprising a second release surface and a third adhesive layer; wherein the second adhesive layer is in contact with the second release surface. In some embodiment, the first and second indicia-containing films are joined by a breakable attachment. In some embodiments, the first release surface is in contact with the second adhesive layer to provide a backing strip for the first adhesive layer and the second adhesive layer. In yet other embodiments, the label further comprises a backing strip in contact with and releasably attached to the second adhesive layer. The breakable attachment may comprise perforations.

In another aspect, a labeled container is provided comprising: a container having an outer surface; and a label as embodied herein, wherein the first adhesive layer and the third adhesive layer are in contact with the outer surface of the container. In some embodiments, the first and second indicia-containing surfaces.

Embodied methods comprise adhering the label, as embodied herein, to a container, the method comprising, contacting the first adhesive layer and the second adhesive layer to an outer surface of the container. Such methods may further comprise removing and/or peeling the second indicia-containing film from the second release surface. Such methods may further comprise breaking the breakable attachment joining the first and second indicia-containing films.

### BRIEF DESCRIPTION OF THE DRAWINGS

FIG. 1 is a cross-sectional representation of a peel-away technical information label, according to one embodiment.

FIG. 2 is a cross-sectional representation of a peel-away technical information label, according to one embodiment.

FIG. 3 is a cross-sectional representation of a peel-away technical information label, according to one embodiment.

FIG. 4 is a representation of a peel-away technical information label, according to one embodiment.

### DETAILED DESCRIPTION

FIG. 1 is a depiction of one embodiment of the invention. The label 5 comprises a release liner 10, a first indicia-containing film 100, and a second indicia-containing film 200, where the first and second indicia-containing films 100, 200 may optionally joined by a breakable attachment 50. The release liner 10 comprises a release surface 12 and a release liner adhesive layer 35. The first indicia-containing film 100 comprises a first indicia-containing surface 25 and a first adhesive layer 15 in contact with the release surface 12. The second indicia-containing film 200 comprises a second indicia-containing surface 30, and a second adhesive layer 20 in contact with the release surface 12. The label 5 may be affixed to any number of surfaces through the release liner adhesive layer 35.

In the present disclosure, various surfaces are associated with various adhesive layers. Unless otherwise noted, such as when a release surface is in contact with an adhesive layer, the relationship of a particular surface to an associated adhesive layer may be analogized to a sheet of paper having an obverse face and a reverse face, where the surface is analogous to an obverse face and the adhesive layer is analogous to the reverse face. For example, in release liner 10 in the above-described embodiment, the release surface 12 is associated with the release liner adhesive layer 35. In such an example, the release liner 10 may be described as comprising the release surface 12 and an oppositely-facing release liner adhesive layer 35.

In another embodiment, the first adhesive layer 15 comprises a first adhesive, and the second adhesive layer 20 comprises a second adhesive, where the first adhesive adheres more strongly to the release surface 12 than does the second adhesive. The stronger adhesion of the one adhesive over another may be used either to facilitate the retention of the indicia-containing film on the release layer such that a container labeled with the label remains identifiable by the label, or to adhere the indicia-containing film to surfaces requiring a stronger adhering adhesive. For example, the first indicia-containing film 100 may be securely adhered to the release liner 10 through the first adhesive layer 15, however the second adhesive indicia-containing film 200 may be capable of being removed for other use via release of second adhesive layer 20 from the release liner 10. The first adhesive layer 15 may comprise a material that allows for release of the first indicia-containing film 100 from the surface of the release liner or container to which it is applied, or of a material that does not allow for easy release of the first indicia-containing film 100 from the surface of the release liner or container to which it is applied. The second adhesive layer 20 may be capable of releasing from the release liner 10, while the first adhesive layer 15 may not be capable of releasing from the release liner 10. Alternatively, the first and second adhesive layers 15, 20 may comprise the same or a similar adhesive.

In another embodiment, the first and second indicia-containing films 100, 200 may be separated by the breakable attachment 50. The breakable attachment 50 may be a perforation or other breakable attachment. Alternatively, the first and second indicia-containing films 100, 200 may be completely separated from each other throughout the thickness of the first and second indicia-containing films 100, 200 and their respective adhesive layers 15, 20, but not through the release liner 10.

The label 5 may further have a backing strip 40 that is in contact with, and releasably attached to, the release liner adhesive layer 35. The backing strip 40 may be of a material, or have a coating, that is readily released from release liner adhesive layer 35.

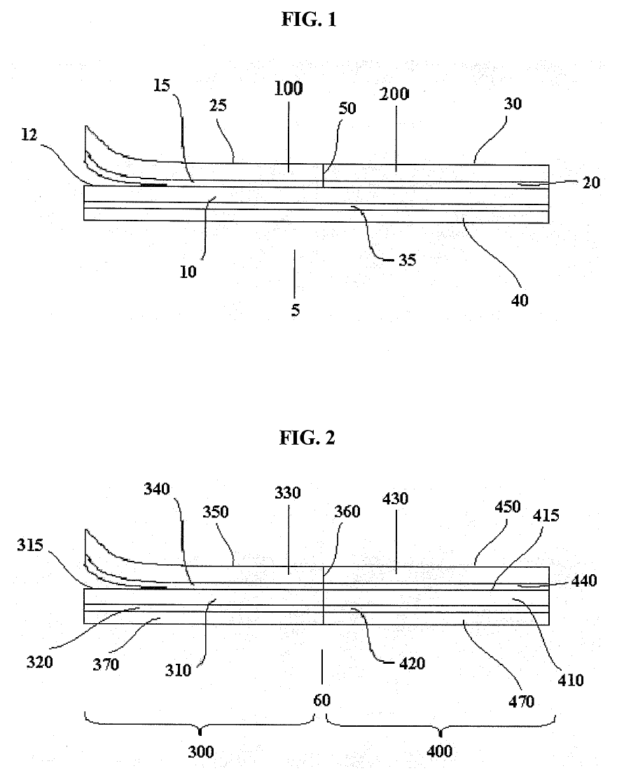

In another embodiment, a label 60 comprises multiple segments such as a first segment 300 and at least a second segment 400 (FIG. 2). The first segment 300 comprises a first release liner 310 comprising a first release liner adhesive layer 320 and a first release surface 315; and a first indicia-containing film 330 comprising a first indicia-containing surface 350 and a first adhesive layer 340 in contact with the first release surface 315. The second segment 400 comprises a second release liner 410 comprising a second release liner adhesive layer 420 and a second release surface 415; and a second indicia-containing film 430 comprising a second indicia-containing surface 450, and a second adhesive layer 440 in contact with the second release surface 415. The first and second segments 300, 400 may optionally be joined by a breakable attachment 360. The breakable attachment 360 may be a perforation or partial separation that is easily breached or separated. Optionally, the first and second release liner adhesive layers 320, 420 may have a protective backing strip 370, 470. The backing strip 370, 470 may be single strip, or it may be a segmented strip joined by a breakable attachment 360. In such embodiments different adhesives may be used in each of the adhesive layers to provide different adhesion properties dependent upon which indicia-containing films or release liners are to be removable or securely attached. As used herein, securely attached refers to attachment of a label to a container such that removal is difficult, and may result in tearing or mutilation of the label.

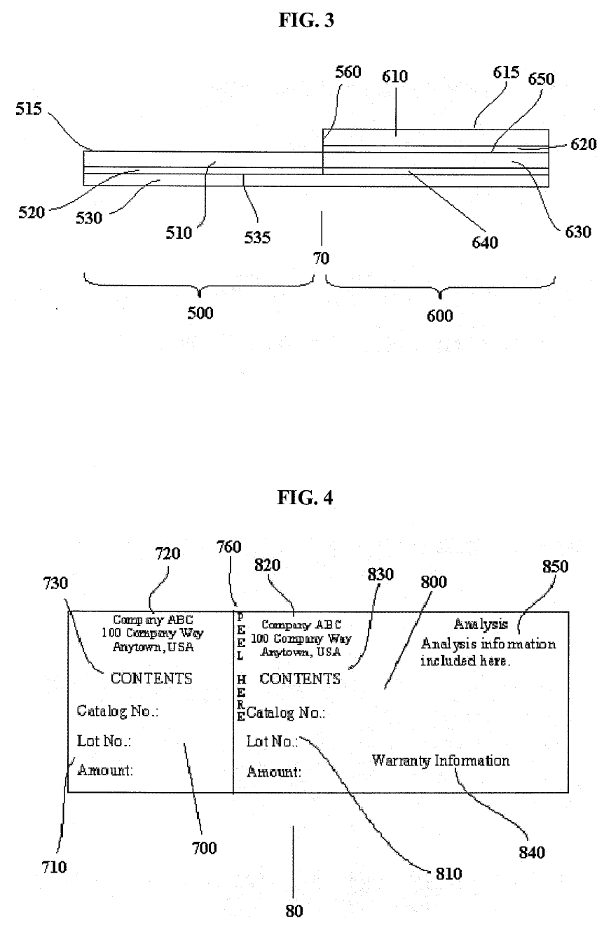

Embodiments are also provided in which one indicia-containing film is directly attached to a container without the use of a separate release liner on that particular indicia-containing film. In such embodiments, the label 70 comprises multiple segments, such as a first segment 500 and at least a second segment 600, optionally joined at least partially by a breakable attachment 560 (FIG. 3). The first segment 500 comprises: a first indicia-containing film 510 comprising a first indicia-containing surface 515 and a first adhesive layer 520; and a first release liner 530 comprising a first release surface 535. The second segment 600 comprises a second indicia-containing film 610 comprising a second indicia-containing surface 615 and a second adhesive layer 620; and a second release liner 630 comprising a second release surface 650 and a third adhesive layer 640. The first release liner 530 may act as a backing strip to protect the adhesive layers 520, 640. The adhesive layers 520, 640 may be separated by the optional breakable attachment 560, or the adhesive layers 520, 640 may be a contiguous adhesive layer. Such embodiments may optionally allow for the use of different adhesives in adhesive layers 520 and 640. The adhesive layers 520, 640 may be comprised of an adhesive that adheres strongly to surfaces such as container surfaces, while the second adhesive layer 620 adheres releasably to the second release liner 630.

In some aspects of the invention, labeled containers are provided comprising a container having an outer surface and any of the labels 5, 60, 70 with the adhesive layers of the release liners in contact with the outer surface of the container. The labels 5, 60, 70 may comprise information regarding the actual or intended contents of the container. For example, a container may have the label 5 as shown in FIG. 1 affixed to the outer surface of the container via an adhesive layer, analogous to that as shown in FIG. 1 as reference numeral 35. Alternatively, a container may have the label 60 as shown in FIG. 2 affixed via adhesive layers 320, 420. In other embodiments, a container may have the label 70 as shown in FIG. 3 affixed via adhesive layers 520, 640. In yet another embodiment, the first indicia-containing film 510 extends to replace the second release liner 630, thus acting as a combination first indicia-containing film and second release liner.

The containers according to the embodiments presented herein, may be made of any material common to the desired application. Common containers include, but are not limited to, vials, test tubes, reagent bottles, specimen bottles, cans, jars, flasks, ampules, etc. Common materials for containers include, but are not limited to, metal, glass, paper, cardboard, plastics, and composite materials. Containers may be painted or coated with other materials commonly used for safety, technical, or aesthetic purposes.

A label, as embodied herein, may contain information regarding the actual or intended contents of the container. FIG. 4 is a non-limiting example of the types of information that may be displayed on the indicia-containing films. FIG. 4 shows an example of a label 80 for a research sample, having a first indicia-containing film 700 and a second indicia-containing film 800. In the context of a research-related label, the information on the indicia-containing films 700, 800 may include catalog numbers, amounts, lot numbers 710, 810, the company name 720, 820 the name of the contents 730, 830, storage conditions, use information such as “for drug use” or “not for drug use,” research use purposes, MSDS information, stability information, or other identifying, contact, or other information relevant to the context of the use of the container, the contents of the container, or the label. An indicator 760 of labeling instructions such as “peel here,” or other information may also be included. Labels embodied herein may be used in a myriad of professional and industrial settings.

In some embodiments, the indicia-containing film, that is not intended to be removed, may contain the same information as the indicia-containing film that remains. Further information may be provided on either indicia-containing film, depending upon the intended use. Again, FIG. 4 is a non-limiting example of such information, including, but not limited to: warranty information 840, a certificate of analysis 850, or other information that the researcher or other individual may want to have available in a notebook, log book, ledger, receipt, or other recordation device. The information on any of the indicia-containing films may be in the form of information, including, but not limited to, printed or typed information, bar-coded information, or as magnetically recorded information. Multiple removable, or peel-away segments of the second indicia-containing films may be present for use by multiple researchers, or in the case of more than one use of the contents of the container. The size of the label may be commensurate with the container for which it is designed, and the size and information recorded may be tailored by the printer or manufacturer to either their own specifications, governmentally required label specifications, or customer specifications.

The indicia-containing films may be made of any material capable of displaying information. The indicia-containing films may be made of paper, plastic, or other composite materials known to those of skill in the art. The indicia-containing films may be made of polyolefin materials. The indicia-containing films may be pigmented or non-pigmented, opaque or transparent. The indicia-containing films may be capable of displaying printed, graphical, recorded and/or magnetic information. The indicia-containing films may have good edge tear resistance with a smooth uniform surface that provides brilliant imagery and superior print qualities. For research and laboratory settings, the indicia-containing films may be chemically resistant, have a wide range of operating temperatures to allow for a variety of use and shipping environments. For example, the operating temperature of the indicia-containing films may be between −196° C. and about −100° C., or between about −140° C. and about 125° C., or between about −46° C. and about 94° C., or between about −25° C. and about 90° C. The materials for the films may have good outdoor and ultra-violet light resistance.

The indicia-containing films for use in the labels 5, 60, 70 embodied herein may be made of any thickness typical for a label in the art. In some embodiments, the indicia-containing film has a thickness of 10 mils or less, where a “mil” is one one-thousandth of an inch. In other embodiments, the indicia-containing film has a thickness from about 1 mil to about 10 mils. This includes embodiments where the indicia-containing film has a thickness of 9 mils or less, embodiments where the indicia-containing film has a thickness of 8 mils or less, embodiments where the indicia-containing film has a thickness of 7 mils or less, embodiments where the indicia-containing film has a thickness of 6 mils or less, embodiments where the indicia-containing film has a thickness of 5 mils or less, embodiments where the indicia-containing film has a thickness of 4 mils or less, and embodiments where the indicia-containing film has a thickness of 3 mils or less.

While the exact adhesive used will depend upon the container material and use conditions, the adhesive layers on the indicia-containing films may be made of a material that has an aggressive, permanent bond with high tack and adhesion to a multitude of surfaces other than the release surfaces. In some embodiments, the adhesives used include, but are not limited to, pressure sensitive adhesives or thermal adhesives. In some embodiments, the adhesive layers on the indicia-containing films include but are not limited to permanent tackified acrylics, polyols, or other adhesives known to those of skill in the art. In some embodiments, suitable adhesives have minimal flow characteristics, and good ultra-violet and chemical resistance. Such characteristics include, but are not limited to, resistance to movement of the label once affixed to a container, resistance to fading in sun-light or other ultra-violet light sources, and resistance to dissolution of adhesive layers from chemical exposure. The adhesive layer on the indicia-containing films for use in the labels 5, 60, and 300 may have a thickness of 5 mils or less in some embodiments; 4 mils or less in other embodiments; 3 mils or less in yet other embodiments; 2 mils or less in further embodiments; or 1 mil or less in other further embodiments.

The release surfaces of the release liners embodied herein, typically comprise a material or coating, known to those of skill in the art, to allow for release of an adhesive layer in contact therewith. The release liners may be made of paper, plastic, or other composite materials known to one of skill in the art where the material, or coating on the material allows for ready release of the adhesive on the indicia-containing films. The release liners may be pigmented or non-pigmented, opaque or transparent. One of skill in the art will immediately recognize materials or coatings that may be used for release liner applications.

Release liners for use in the labels 5, 60, 70 embodied herein may be made of any thickness typical for a label in the art. In some embodiments, the release liner has a thickness of 8 mils or less. This includes embodiments where the release liner has a thickness of 6 mils or less, embodiments where the release liner has a thickness of 5 mils or less, embodiments where the release liner has a thickness of 4 mils or less, and embodiments where the release liner has a thickness of 3 mils or less. For example, the release liner may have a thickness from about 1 mil to about 8 mils.

Also provided herein are methods of using labels of the invention. The following description references the label as shown in FIG. 1, however, the method described is applicable to all labels of the invention, including other embodiments disclosed herein, as will be apparent to those of skill in the art. In embodiments in which a backing strip is used, the backing strip is first removed to expose the release liner adhesive layer 35. The exposed release liner adhesive layer 35 is then contacted with an outer surface of a container. When the container is used or its receipt recorded, the second indicia-containing film 200 may be removed (e.g. peeled away) from the release surface 12 leaving the first indicia-containing film 100 on the container. The removed, second indicia-containing film 200 may then be applied to any other surface. In the case of a research sample, the other surface may be a notebook, reaction vessel, log book, collection vessel, new container, etc. In the case of other samples or products labeled with labels of the invention, the other surface may be a log book, customer information sheet, receipt, or other surface to which the label may be attached. Thus, the methods generally comprise the steps of contacting and peeling.

For the purposes of this disclosure and unless otherwise specified, “a” or “an” means “one or more.”

As used herein, “about” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term.

One skilled in the art will readily realize that all ranges discussed can and do necessarily also describe all subranges therein for all purposes and that all such subranges also form part and parcel of this invention. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

While some embodiments have been illustrated and described, it should be understood that changes and modifications can be made therein in accordance with ordinary skill in the art without departing from the invention in its broader aspects as defined in the following claims.

What is claimed is:

1. A label comprising:
(a) a release liner comprising a release surface, and a release liner adhesive layer;
(b) a first indicia-containing film comprising a first indicia-containing surface, and a first adhesive layer in contact with the release surface of the release liner; and
(c) a second indicia-containing film comprising a second indicia-containing surface, and a second adhesive layer in contact with the release surface of the release liner.

2. The label of claim 1, further comprising a backing strip in contact with and releasably attached to the release liner adhesive layer.

3. The label of claim 1, wherein the first adhesive adheres more strongly to the release surface of the release liner than does the second adhesive layer.

4. A label comprising:
(a) a first release liner comprising a first release surface;
(b) a first indicia-containing film comprising a first adhesive layer in contact with the first release surface and a first indicia-containing surface;
(c) a second indicia-containing film comprising a second adhesive layer and a second indicia-containing surface; and
(d) a second release liner comprising a second release surface and a third adhesive layer;
wherein the second adhesive layer is in contact with the second release surface.

5. The label of claim 4, wherein the first release surface is also in contact with the second adhesive layer, to provide a backing strip for the first adhesive layer and the third adhesive layer.

6. The label of claim 4, further comprising a backing strip in contact with and releasably attached to the third adhesive layer.

7. The label of claim 4, wherein the breakable attachment comprises perforations.

8. A labeled container comprising:
(a) a container having an outer surface; and
(b) the label of claim 1,
wherein the release liner adhesive layer is contact with the outer surface of the container.

9. The container of claim 8, wherein the first and second indicia-containing surfaces comprise information regarding actual or intended contents of the container.

10. A labeled container comprising:
(a) a container having an outer surface; and
(b) the label of claim 4,
wherein the first adhesive layer and the third adhesive layer are in contact with the outer surface of the container.

11. The container of claim 10, wherein the first and second indicia-containing surfaces comprise information regarding actual or intended contents of the container.

12. A method for using the label of claim 1 comprising, contacting the release liner adhesive layer to an outer surface of the container.

13. The method of claim 12, further comprising removing the second indicia-containing film from the release surface of the release liner.

14. A method of using the label of claim 4 comprising, contacting the first adhesive layer and the third adhesive layer to an outer surface of the bottle.

15. The method of claim 14, further comprising removing the second indicia-containing film from the second release surface.

16. The method of claim 14, further comprising breaking the breakable attachment joining the first and second indicia-containing films.
